(19) United States
(12) Patent Application Publication
(10) Pub. No.: US 2011/0310529 A1
(43) Pub. Date: Dec. 22, 2011

(54) Electrochemical capacitor and method for manufacturing the same

(75) Inventors: Hong Seok Min, Yongin (KR); Hak Kwan Kim, Hanam (KR); Hyun Chul Jung, Yongin (KR); Dong Hyeok Choi, Suwon (KR)

(73) Assignee: SAMSUNG ELECTRO-MECHANICS CO., LTD., Suwon (KR)

(21) Appl. No.: 12/926,456

(22) Filed: Nov. 18, 2010

(30) Foreign Application Priority Data
Jun. 21, 2010 (KR) 10-2010-0058759

(51) Int. Cl. H01G 9/058; H01G 9/00

(52) U.S. Cl. 361/502; 156/150

(57) ABSTRACT

There are provided an electrochemical capacitor and a method for manufacturing the same. The electrochemical capacitor according to the present invention includes: a plurality of first and second electrodes disposed to be opposite to each other; a separator disposed between the first and second electrodes; wherein at least one of the plurality of first electrodes is made of an electrode material doped with lithium ions and a lithium layer having the dendrite is formed on the surface of the electrode material.

### CROSS-REFERENCE TO RELATED APPLICATIONS

This application claims the priority of Korean Patent Application No. 10-2010-0058759 filed on Jun. 21, 2010, in the Korean Intellectual Property Office, the disclosure of which is incorporated herein by reference.

### BACKGROUND OF THE INVENTION

1. Field of the Invention

The present invention relates to an electrochemical capacitor and a method for manufacturing the same, and more particularly, to an electrochemical capacitor including an electrode on which a lithium layer having a dendrite is formed and a method for manufacturing the same.

2. Description of the Related Art

A stable supply of energy is an important factor in the operation of various electronic products such as information telecommunication devices. Generally, the function is performed by a capacitor. That is, the capacitor serves to charge and discharge electricity in and from circuits of the information telecommunication devices and various electronic products, thereby making it possible to stabilize the electricity flow in the circuits. The general capacitor has a very short charging and discharging time and a long lifespan but has a limitation in being used as an electrical storage device due to a high output density and a small energy density.

In order to overcome this limitation, a new capacitor such as an electric double layer capacitor having a very short charging and discharging time and high output density has been recently developed, which has come into prominence as a next-generation energy device, together with a rechargeable battery.

Recently, various electrochemical devices operated on a principle similar to that of the electric double layer capacitor have been developed and an energy storage device called a hybrid capacitor, according to a combination of the charging principles of the lithium ion rechargeable battery and the electric double layer capacitor, has come into prominence. In the case of this hybrid capacitor, there has been proposed a lithium ion capacitor having holes penetrating through the front and rear surfaces formed on a cathode current collector and an anode current collector, using materials capable of reversibly transporting lithium ions as anode electrode materials, disposing a lithium metal on an anode or a cathode disposed to be opposite to each other, and transporting the lithium ions to the anode by the electrochemical contact therewith.

The lithium ion capacitor has holes penetrating through the front and rear surfaces formed on the current collector to move the lithium ions to the current collector without being blocked, such that it can electrochemically transport the lithium ions to a plurality of stacked anodes even in a power storage device configured of cells having a large number of stacks.

However, the lithium ion capacitor has problems in that it takes a great deal of time to transport the lithium ions using the lithium metal and it increases a dead volume due to the lithium metal existing in the assembled cell.

### SUMMARY OF THE INVENTION

An aspect of the present invention provides an electrochemical capacitor including an electrode on which a lithium layer having a dendrite is formed and a method for manufacturing the same

According to an aspect of the present invention, there is provided an electrochemical capacitor, including: a plurality of first and second electrodes disposed to be opposite to each other; a separator disposed between the first and second electrodes; wherein at least one of the plurality of first electrodes is made of an electrode material doped with lithium ions and a lithium layer having the dendrite is formed on the surface of the electrode material.

The lithium layer having the dendrite may be formed under a voltage of 0V or less.

The first and second electrodes may be formed by forming the first and second materials on first and second conductive sheets, wherein the first and second conductive sheets are provided with a plurality of through holes.

The first electrode may be set as an anode and the second electrode may be set as a cathode.

According to an aspect of the present invention, there is provided a method for manufacturing an electrochemical capacitor, including: preparing a plurality of first electrodes with an electrode material doped with lithium ions; doping at least one of the plurality of first electrodes with the lithium ions and forming a lithium layer having a dendrite on the surface of the electrode material; and preparing a capacitor laminate by disposing the plurality of first electrodes and a plurality of second electrodes to be opposite to each other and disposing separators between the first and second electrodes.

The doping of the first electrode with the lithium ions may be performed by applying a voltage of 0V or more to the first electrode and a counter electrode including lithium.

The forming of the lithium layer having the dendrite may be performed by applying a voltage of 0V or less to the first electrode and the counter electrode including lithium.

The doping of the first electrode with the lithium ions and the forming of the lithium layer having the dendrite may be continuously performed by controlling voltage.

The method for manufacturing an electrochemical capacitor may further include measuring the thickness of the lithium layer having the dendrite.

The method for manufacturing an electrochemical capacitor may further include doping the plurality of first electrodes with the lithium ions from the lithium layer having the dendrite by impregnating the capacitor laminate in an electrolyte.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a lithium ion capacitor according to an exemplary embodiment of the present invention; and

FIGS. 2A to 2E are diagrams showing each process of a method for manufacturing a lithium ion capacitor according to an exemplary embodiment of the present invention.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

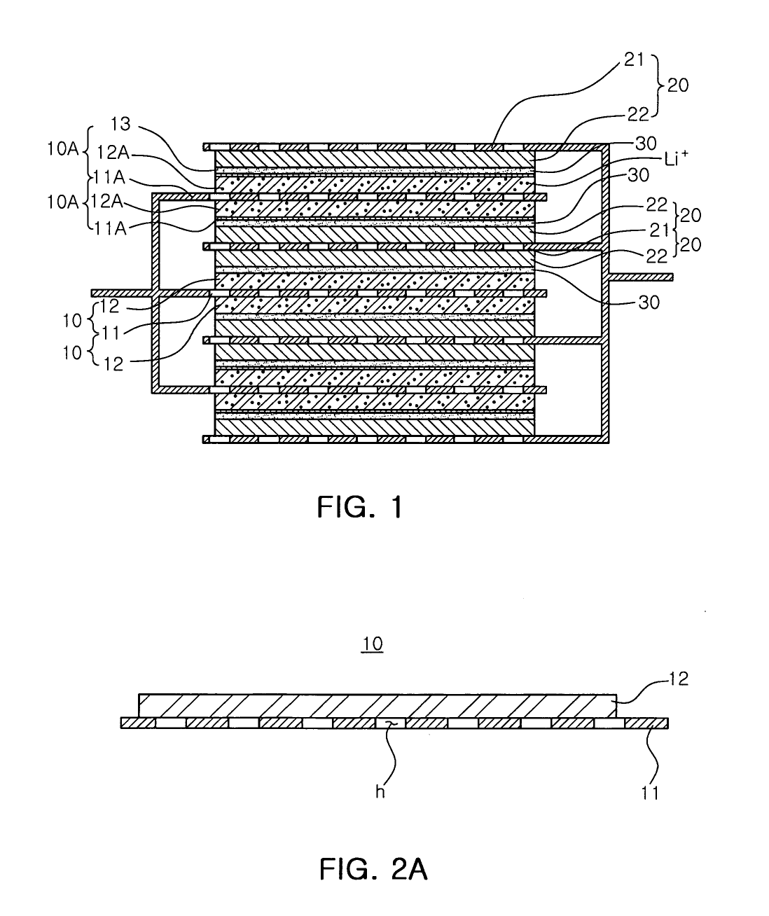

A lithium ion capacitor that is an example of an electrochemical device according to the present invention will be described with reference to FIG. 1. FIG. 1 is a schematic cross-sectional view showing a lithium ion capacitor according to an exemplary embodiment of the present invention.

Referring to FIG. 1, a lithium ion capacitor according to the present invention includes a plurality of first electrodes 10 and 10Aa and second electrodes 20 that are disposed to face each other and a separator 30 disposed between the first and second electrodes.

Electricity having different polarities is applied to the first and second electrodes 10, 10A, and 20. The number of first and second electrodes to be disposed may be appropriately stacked in order to obtain the desired electrical capacity.

In the exemplary embodiment, the first electrodes 10 and 10A may be set to be an “anode” and the second electrode 20 may be set to be a “cathode”.

The first electrodes 10 and 10A may be formed by forming first electrode materials 12 and 12A on first conductive sheets 11 and 11A.

As shown, the first electrodes 10 and 10A may be double-sided electrodes formed by forming the first electrode materials 12 and 12A on both sides of the first conductive sheets 11 and 11A.

The first electrode materials 12 and 12A may be reversibly doped lithium ions; however, they are not limited thereto. For example, the first electrode materials 12 and 12A may be a carbon material, such as graphite, hard carbon, coke, and the like, or polyacene-based materials, and the like.

In addition, the first electrodes 10 and 10A may be formed by mixing the first electrode materials 12 and 12A with the conductive materials; however, the conductive material is not limited thereto. For example, the conductive materials may include acetylene black, graphite, metal powder, or the like.

The thickness of the first electrode materials 12 and 12A is specifically not limited but may be formed at, for example, 15 to 100 μm.

The first conductive sheets 11 and 11A serve as collectors that transfer electrical signals to the first electrode materials 12 and 12A and collect the accumulated charges, and may be made of a metallic foil, a conductive polymer, or the like. The metallic foil may be made of stainless steel, copper, nickel, or the like.

The first conductive sheets 11 and 11A may be formed with through holes. During the doping of the lithium ions, the lithium ions may move by passing through the plurality of first and second electrodes due to the through holes provided therein.

In addition, as shown, the plurality of first conductive sheets 11 and 11A may be collected into a single sheet to be connected to external terminals so as to apply electricity to the lithium ion capacitor.

In addition, although not shown, the first electrode material is manufactured as a sheet in a solid sheet without using the first conductive sheet, such that it can form the first electrode.

The second electrode 20 may be made by forming a second electrode material 22 on a second conductive sheet 21. As shown, the second electrodes 20 may be a double-sided electrode formed by forming the second electrode material 22 on both sides of the second conductive sheet 21.

The second electrode material 22 is not specifically limited but may be, for example, activated carbon and a mixture of the activated carbon, the conductive material, and a binder.

The thickness of the second electrode material 22 is not specifically limited but may be formed at, for example, a thickness of 15 to 100 μm.

The second conductive sheet 21 serves as a collector that transfers electrical signals to the second electrode material 22 and collects the accumulated charges and may be made of a metallic foil, a conductive polymer, or the like. The metallic foil may be made of aluminum, stainless steel, or the like.

The second conductive sheet 21 may be formed with through holes. During the doping of the lithium ions, the lithium ions may move by passing through the plurality of first and second electrodes due to the through holes provided therein.

In addition, as shown, the plurality of second conductive sheets 21 may be collected into a single sheet to be connected to external terminals in order to apply electricity to the lithium ion capacitor.

In addition, although not shown, the second electrode material is manufactured as a sheet in a solid sheet without using the second conductive sheet, such that it can be as the second electrode.

The separator 30 may be disposed between the first and second electrodes in order to provide electrical isolation therebetween. In this case, an example of a porous material may include, for example, polypropylene, polyethylene, a glass fiber, or the like.

In the exemplary embodiment, at least one electrode 10A of the plurality of first electrodes 10 and 10A may be formed by doping the lithium ions within the first electrode material 12A and forming the lithium layer 13 on the surface of the first electrode material 12A.

The lithium layer 13 may be formed by forming the lithium atoms in the dendrite. The lithium layer 13 having the dendrite may be formed at a voltage of 0V or less. A method for manufacturing the first electrode 10A formed with the lithium layer 13 according to the exemplary embodiment will be described in detail below.

The first electrode 10A is impregnated in an electrolyte, the lithium ions are generated in the lithium layer 13 formed in the first electrode 10A, and the lithium ions move to the plurality of other first electrodes 10 so that each of the first electrode materials 12 may be doped with the lithium ions. The lithium layer 13 having the dendrite has the wide specific surface area to increase the generation efficiency of the lithium ions.

The thickness of the lithium layer 13 is not specifically limited but may be determined according to the amount of lithium ions required for the lithium ion capacitor.

In the lithium ion capacitor, the number and installation positions of first electrodes 10A in which the lithium layer 13 is formed may be formed according to the amount of lithium ions required for the lithium ion capacitor. The amount of lithium ions necessary for doping may be optimized according to the number and installation positions of first electrodes 10A in which the lithium layer is formed and the thickness of the lithium layer and the electrode material may be uniformly doped with lithium. Therefore, the energy density of the lithium ion capacitor may be improved.

In the related art, the plurality of first and second electrodes are stacked for doping the lithium ions and then, the separate lithium metal sheet is disposed on one surface of a laminate. The method of doping the lithium ions from the lithium metal sheet is used. When doping the lithium ions by using the lithium metal sheet, a long duration of time is required, and the dead volume is increased due to the lithium metal sheet.

However, in the exemplary embodiment of the present invention, the lithium ions can be doped by the lithium layer having the dendrite. The doping time may shortened by generating the lithium ions from the lithium layer. The lithium ion capacitor does not have to include the separate lithium metal sheet and reduces the thickness of the lithium layer during the time of impregnating and using the electrolyte, such that it can be compact.

The method for manufacturing the lithium ion capacitor according to the exemplary embodiment of the present invention will now be described.

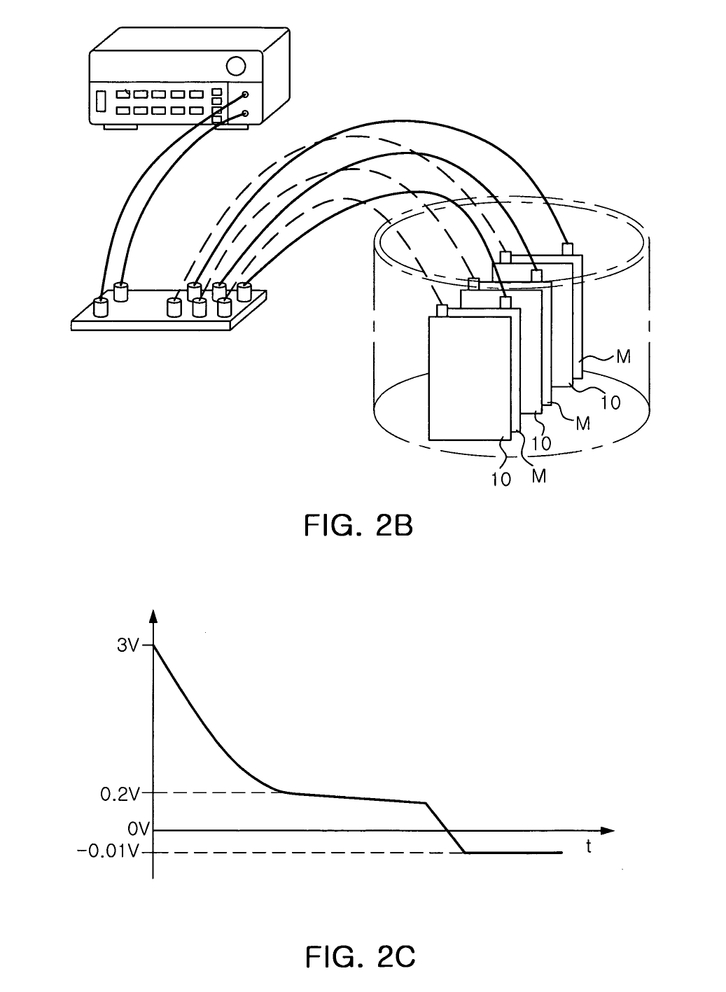

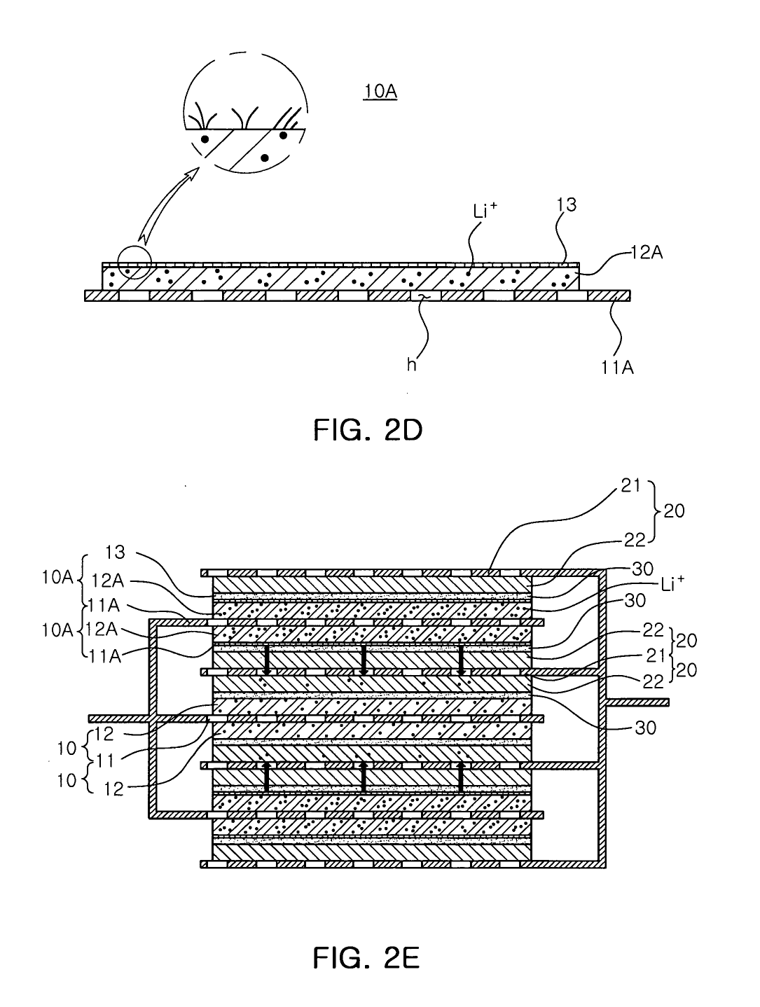

FIGS. 2A and 2E are diagrams showing each process of a method for manufacturing a lithium ion capacitor according to an exemplary embodiment of the present invention.

As shown in FIG. 2A, the first electrode 10 is initially prepared by applying the first electrode material 12 to the first conductive sheet 11.

The first conductive sheet 11 may be a foil type. After the first electrode material 12 is formed in the first conductive sheet 11, a through hole (a through hole h of the first conductive sheet, a through hole (not shown) of the first electrode material) may be formed in the first conductive sheet and the first electrode material.

When the electrode material is formed on the first conductive sheet formed with the through hole, a movable electrode material slurry may be discharged through the through hole so that it is difficult to control the thickness of the electrode material. Therefore, when the first electrode material is formed and then, the through hole is formed, the above-mentioned problem can be solved.

Next, the first electrode 10 is doped with the lithium ions and the lithium layer is formed.

As shown in FIG. 2B, the first electrode 10 is inserted into the electrolyte including a lithium salt. A metal M including lithium is set to be a counter electrode. Current is applied to the counter electrode.

The metal M including the lithium is not specifically limited as long as it is able to supply lithium ions. For example, the metal capable of supplying the lithium ions, including the lithium elements such as a lithium metal or a lithium-aluminum alloy may be used.

If current is applied and then, voltage is slowly lowered, the lithium ions from the metal M including lithium are emitted and the first electrode material 12 is doped with the lithium ions. Therefore, when the voltage applied thereto is lowered to be 0.2 V or less, the lithium layer 13 is formed on the surface of the first electrode material. The lithium layer 13 is made of lithium having the dendrite.

The lithium layer 13 may be continuously formed on the first electrode material 12 after doping the lithium ions by applying current and then, lowering voltage to be 0V or less.

The thickness of the formed lithium layer 13 may be measured. The thickness of the lithium layer 13 or the amount of the lithium ions may be controlled and measured by the electrochemical setting conditions and may be optimized to meet the capacity of the lithium ion capacitor.

FIG. 2C is a graph showing the change in voltage according to the process of doping the lithium ions and forming the lithium layer. Referring to FIG. 2C, the electrode material is doped with the lithium ions at 0.2 V or more and the lithium layer having the dendrite is formed on the surface of the electrode material when voltage is lowered from 0.2 V or less to 0 V or less. In order to form the lithium layer having the dendrite, the voltage may be lowered to −0.01 V.

FIG. 2D is a cross-sectional view schematically showing the first electrode 10A in which the first electrode material 12A is doped with the lithium ions and the lithium layer 13 is formed on the surface thereof.

Referring to FIG. 2D, the first electrode material 12 forming the first electrode 10A is doped with the lithium ions and the surface of the first electrode material 12 is formed with the lithium layer 13. The lithium layer 13 is made of lithium having the dendrite and the lithium layer having the dendrite has a wide specific surface area in order to increase the emission efficiency characteristics of the lithium ions.

Generally, the electrode doped with the lithium ions is very sensitive to moisture, which makes it difficult to handle the electrode in the subsequent stacking and packaging processes. However, the first electrode 10A according to the exemplary embodiment of the present invention has the lithium layer 13 formed on the surface thereof, such that it is easy to handle the first electrode 10A.

Next, as shown in FIG. 2E, the plurality of first electrodes 10 and 10A, the plurality of separators 30, and the plurality of second electrodes 20 are prepared. The laminate is prepared by disposing the first and second electrodes to be opposite to each other and disposing the separator between the first and second electrodes.

The first electrodes 10 and 10A may be manufactured by applying the first conductive sheets 11 and 11A with the first electrode materials 12 and 12A and the second electrode 20 may be manufactured by applying the second conductive sheet 21 with the second electrode material 22.

The first and second electrodes may be manufactured as a double-sided electrode by forming the electrode material on both surfaces of the first and second conductive sheets.

As described above, a part of the plurality of first electrodes 10 and 10A may be the first electrode 10A in which the first electrode material is doped with the lithium ions and the lithium layer is formed on the surface thereof. The number and installation positions of first electrodes 10A in which the lithium layer 13 is formed may be appropriately formed according to the amount of lithium ions required for the lithium ion capacitor.

The plurality of first and second conductive sheets may be collected into one to be connected to the external terminals. Thereafter, the laminate may be received in the case during the package process. The first and second conductive sheets may be connected to the external terminals and the electrolyte may be injected into the case. The electrolyte is not limited thereto and a non-protic organic solvent electrolyte of the lithium salt may be used.

The laminate is impregnated in the electrolyte and then, the plurality of first electrodes 10 and 10A are electrically shorted from each other. The lithium ions are emitted from the first electrode 10A, in which the lithium layer 13 is formed, by the electrical short, which are doped to the first electrode material 12 of the stacked other first electrode 10. The lithium layer 13 having the dendrite has the wide specific surface area to increase the generation efficiency of the lithium ions. The exemplary embodiment of the present invention uses the first electrode in which the lithium layer 13 is formed to perform the doping process, such that it does not have to include the lithium metal in the package, thereby making it possible to make the lithium ion capacitor small.

In addition, the time of the doping process can be shortened by appropriately disposing the first electrode layer in which the lithium layer is formed.

As set forth above, the electrochemical capacitor includes the electrode in which the lithium layer having the dendrite is formed. The plurality of stacked electrodes can be doped with the lithium ions by the lithium layer having the dendrite.

The amount of the lithium ions necessary for doping can be optimized and the electrode material can be uniformly doped with lithium, by controlling the number and installation position of electrodes in which the lithium layer having the dendrite is formed and the thickness of the lithium layer having the dendrite. Therefore, the energy density of the lithium ion capacitor can be improved.

In addition, the electrochemical capacitor does not have to include the separate lithium metal sheet such that the electrochemical capacitor can be compact.

The lithium layer having the dendrite expands the specific surface area to increase the generation efficiency of the lithium ions, thereby making it possible to shorten the doping time of the lithium ions and the electrode in which the lithium layer having the dendrite is formed is more easily handled, thereby making it possible to simplify the manufacturing process.

While the present invention has been shown and described in connection with the exemplary embodiments, it will be apparent to those skilled in the art that modifications and variations can be made without departing from the spirit and scope of the invention as defined by the appended claims.

What is claimed is:

1. An electrochemical capacitor, comprising:
a plurality of first and second electrodes disposed to be opposite to each other;
a separator disposed between the first and second electrodes;
wherein at least one of the plurality of first electrodes is made of an electrode material doped with lithium ions and a lithium layer having the dendrite is formed on the surface of the electrode material.

2. The electrochemical capacitor of claim 1, wherein the lithium layer having the dendrite is formed under a voltage of 0V or less.

3. The electrochemical capacitor of claim 1, wherein the first and second electrodes are formed by forming the first and second materials on first and second conductive sheets, the first and second conductive sheets being provided with a plurality of through holes.

4. The electrochemical capacitor of claim 1, wherein the first electrode is set as an anode and the second electrode is set as a cathode.

5. A method for manufacturing an electrochemical capacitor, comprising:
preparing a plurality of first electrodes with an electrode material doped with lithium ions;
doping at least one of the plurality of first electrodes with the lithium ions and forming a lithium layer having a dendrite on the surface of the electrode material; and
preparing a capacitor laminate by disposing the plurality of first electrodes and a plurality of second electrodes to be opposite to each other and disposing separators between the first and second electrodes.

6. The method for manufacturing an electrochemical capacitor of claim 5, wherein the doping of the first electrode with the lithium ions is performed by applying a voltage of 0V or more to the first electrode and a counter electrode including lithium.

7. The method for manufacturing an electrochemical capacitor of claim 5, wherein the forming of the lithium layer having the dendrite is performed by applying a voltage of 0V or less to the first electrode and the counter electrode including lithium.

8. The method for manufacturing an electrochemical capacitor of claim 5, wherein the doping of the first electrode with the lithium ions and the forming of the lithium layer having the dendrite are continuously performed by controlling voltage.

9. The method for manufacturing an electrochemical capacitor of claim 5, further comprising measuring the thickness of the lithium layer having the dendrite.

10. The method for manufacturing an electrochemical capacitor of claim 5, further comprising doping the plurality of first electrodes with the lithium ions from the lithium layer having the dendrite by impregnating the capacitor laminate in an electrolyte.
